(19) United States
(12) Patent Application Publication
(10) Pub. No.: US 2023/0242729 A1
(43) Pub. Date: Aug. 3, 2023

(54) PEI PARTICLE FOAMS WITH DEFINED RESIDUAL BLOWING AGENT CONTENT

(71) Applicant: Evonik Operations GmbH, Essen (DE)

(72) Inventors: Christian Traßl, Warmensteinach (DE); Kay Bernhard, Darmstadt (DE); Dirk Roosen, Mobile, AL (US); Denis Holleyn, Hofheim am Taunus (DE); Vinod Paremal, Mumbai (IN)

(73) Assignee: Evonik Operations GmbH, Essen (DE)

(21) Appl. No.: 18/003,666

(22) PCT Filed: Jun. 18, 2021
(86) PCT No.: PCT/EP2021/066551

§ 371 Date: Dec. 28, 2022

(30) Foreign Application Priority Data
Jul. 1, 2020 (EP) 20183473.6

(51) Int. Cl. C08J 9/228; C08J 9/36; B29C 71/02

(52) U.S. Cl. CPC C08J 9/228; C08J 9/36; B29C 71/02; C08J 2379/08; C08J 2205/04; C08J 2203/12; C08J 2203/14; C08J 2203/16; C08J 2203/06; C08J 2203/10; B29K 2079/085

(57) ABSTRACT

Polymer foams based on polyetherimides (PEI) meet the legal requirements of the aerospace industry for both the interior and exterior of aircraft.

### FIELD OF THE INVENTION

The purpose of the present invention is to provide a new process for the production of a polyetherimide (PEI) particle foam, characterized in that the foamed PEI has a glass transition temperature between 180 and 220° C., measured according to DIN EN ISO 6721-1, and that the average cell diameter of the particle foam is less than 2 mm, with a density of 10-200 kg/m³ determined according to DIN EN ISO 1183 and in the moldings with a thickness of 2-60 mm the energy release according to AITM 2. 0006 is maximum 65 kW/m² (HRR) and within 2 minutes 2-65 kWmin/m² (HR).

### PRIOR ART

Foam materials suitable for installation in the aerospace industry are common knowledge. However, the majority of the foams described for this purpose are composed of pure PMI (polymethacrylimide), PPSU (polyphenylene sulfones) or PES (polyether sulfones) only. Also to be found in the literature is PVC (polyvinyl chloride) although it is unsuitable from a toxicological point of view. All these materials have been used to date exclusively as block or sheets materials.

Other materials have also been described in less detail as sheet materials for installation in the aerospace industry. Poly(oxy-1,4-phenylsulfonyl-1,4-phenyl) (PESU) is an example of such a material. This is sold, for example, under Divinycell F by DIAB. In the further processing of these extruded foam sheets, however, uneconomically large amounts of wastage material arise.

An economic method for avoidance of cutting waste in the production of three-dimensional foam moldings is the use of foam particles (bead foams) rather than block foams. All the particle foams available according to the prior art have either drawbacks in the case of use at high temperatures or else non-optimal mechanical properties overall, especially at these high temperatures. Furthermore, only very few existing foams are not extremely flammable and therefore qualify for installation in the interiors of, for example, automotive vehicles, rail vehicles or aircrafts. For example, particle foams based on polypropylene (EPP), polystyrene (EPS), thermoplastic polyurethane elastomer (E-TPU) or PMI (ROHACELL Triple F) have inadequate flame retardancy, while all inherently flame-retardant polymers that are suitable in principle, for example PES, PEI or PPSU, are processed solely to give block foams according to the current prior art.

An economical method of avoiding waste cuttings in the production of three-dimensional foam moldings is the use of bead foams instead of block foams. All particle foams available according to the state of the art have either disadvantages when used at high temperatures or overall, and especially at these high temperatures, sub-optimal mechanical properties. In addition, only very few foams are known which are not easily flammable and can therefore be used in the interiors of automotive vehicles, rail vehicles or aircrafts. For example, particle foams based on polypropylene (EPP), polystyrene (EPS), thermoplastic polyurethane elastomer (E-TPU) or PMI (ROHACELL Triple F) have an insufficient flame-retardant effect, while all inherently flame-retardant polymers that are suitable in principle, such as PES, PEI, PEEK or PPSU, are only processed into block foams according to the current state of the art.

However, the inherently flame-retarded polymers sometimes contain large quantities of residual blowing agents after processing into block foams, which do not meet the requirements, for example in aircraft construction.

### Problem

The problem addressed by the present invention was, regarding the prior art, was that of providing a process that can ensure a low residual blowing agent content in the molded part of a PEI particle foam.

A further task is to provide a PEI particle foam for use in aircraft construction.

Further non-explicit tasks may result from the description, claims or examples in this text without being explicitly mentioned here.

### Solution

The problems are solved by providing a new process for the production of a polyetherimide (PEI) particle foam, characterized in that the foamed PEI has a glass transition temperature between 180 and 220° C., measured according to DIN EN ISO 6721-1 (Publication date: 2011-08), and that the average cell diameter of the particle foam is less than 2 mm, with a density of 10-200 kg/m³ determined according to DIN EN ISO 1183-1 (Publication date: 2013-04) and in the molded part with a thickness of 2-60 mm the energy release according to AITM 2. 0006 (ASTM E 906; Publication date: 2017-01) is a maximum of 65 kW/m² (HRR) and within 2 minutes 2-65 kWmin/m² (HR) by flushing the particle foam with a fluid during the mold foaming process and discharging the blowing agent and, if necessary, subsequently heat treating it.

In particular, these problems are solved by providing polymer mixtures containing polyetherimide (PEI) and at least one nucleating agent for the production of foams with a density of 10 to 200 kg/m³ determined according to DIN EN ISO 1183-1 and a glass transition temperature, measured according to DIN EN ISO 6721-1, between 180 and 220° C.

Suitable are polymer blends which, prior to foaming and tempering, consist of 77.01 to 99.5% by weight of PEI, 0.49 to 19.99% by weight of a blowing agent, 0.01 to 3% by weight of a nucleating agent and 0% to 10% by weight of additives.

Polymer blends containing 1% to 19% by weight of a blowing agent are preferred.

The choice of blowing agent is relatively free and is determined for the technician in particular by the foaming method selected, the solubility in the polymer and the foaming temperature. Suitable foaming agents are, for example, alcohols, such as isopropanol or butanol, ketones, such as acetone or methyl ethyl ketone, alkanes, such as iso- or n-butane, or -pentane, hexane, heptane or octane, alkenes, such as pentene, hexene, heptene or octene, CO₂, N₂, water, ethers, such as diethyl ether, aldehydes, such as formaldehyde or propanal, fluoro(chloro)hydrocarbons, chemical blowing agents or mixtures of several of these substances.

Chemical blowing agents are less volatile or non-volatile substances which are chemically decomposed under foaming conditions to form the actual blowing agent. A very simple example is tert-butanol, which forms isobutene and water under foaming conditions. Further examples are NaHCO₃, citric acid and its derivatives, azodicarbonamide (ADC) and its compounds, toluenesulfonylhydrazine (TSH), oxybis(benzosulfohydroazide) (OBSH) or 5-phenyl-tetrazole (5-PT).

For various applications of a PEI particle foam it is of great importance that the residual blowing agent content is as low as possible and that the energy release according to AITM 2.0006 in a particle foam is reduce to a value below 65 kW/m² (HRR) by reducing the residual blowing agent content. Preferably, the energy release according to AITM 2.0006 is a maximum of 65 kW/min² (HRR) and within 2 minutes 2-65 kWmin/m² (HR), particularly preferably within 2 minutes test duration 10-65 kWmin/m². Since the energy release depends on the volume of the sample, the sample size must be predefined for the OSU (Ohio State University) test used here.

The sample size is 150 mm×150 mm×installation thickness. The moldings used in this invention have an installation thickness between 2 and 60 mm. Preferably they have a thickness between 5 and 20 mm.

The process according to the invention is characterized by the fact that the particle foam is flushed with a fluid during the mold foaming process. The blowing agent is discharged during this process step. The preferred fluids are steam or hot air.

If the residual blowing agent content is still too high after this process step, and thus the energy release according to AITM 2.0006 is above 65 kW/min² (HRR) and within 2 minutes above 65 kWmin/m² (HR), an optional thermal post-treatment can be carried out.

Tempering is then preferred. Depending on the remaining residual blowing agent content, tempering is carried out at a temperature between 50 and 200° C. for 0.1 h to 72 h.

Suitable devices in the sense of the invention are, for example, tempering oven, heatable drums, boilers or also a moving belt in combination with a heat source, preferably a continuous oven. The movable belt is for example a conveyor belt which feeds the molded parts to the heat source.

The technician knows many opportunities for feeding the molded parts to the device. For example, he can feed them manually or with mechanical assistance, for example, by means of a trolley. Depending on the type of apparatus, the molded parts are either brought inside the apparatus or placed on a part of the apparatus (e.g. on the conveyor belt so that the molded parts can be fed to a heat source).

In this way the tempering can preferably be carried out in a large oven with several workpieces at the same time. Individual molded parts are then removed from this oven.

The device has a possibility to heat the molded parts. The technician knows numerous methods for this. For example, suitable IR radiation sources, (saturated) water vapor, radio waves, microwaves, electromagnetic waves, hot air, one or more resistance oven or combinations of the above can be used. The heat can be transferred directly (e.g. by radiation) or indirectly by heat conduction (e.g. through a wall of a heatable drum or boiler heated by steam or similar heat sources) to the molded parts.

Mold foaming and tempering can also be carried out in the same device, e.g. by an optional temperature change and switching on the microwave sources after foaming. However, it is preferable to perform both steps in separate devices.

Additionally, foams usually contain different additives. Depending on the type of additive, 0 to 10% by weight of an additive is added to polymer blends. The additives are flame retardant additives, plasticizers, pigments, UV stabilizers, nucleating agents, impact modifiers, adhesion promoters, rheology modifiers, chain extenders, fibers, platelets and/or nanoparticles.

Phosphorus compounds, especially phosphates, phosphines or phosphites are usually used as flame retardant additives. Suitable UV stabilizers or UV absorbers are generally known to the specialist. Usually, HALS compounds, tiuvines or triazoles are used. Polymer particles with an elastomer or soft phase are usually used as impact modifiers. These are often core (shell) shell particles, with an outer shell which as such is at most weakly cross-linked and as a pure polymer would have at least minimal miscibility with the PEI. In principle, all known pigments can be used as pigments.

Suitable plasticizers, rheology modifiers and chain extenders are generally known to technicians from the manufacture of films, membranes or molded parts made of PEI and can accordingly be transferred with little effort to the manufacture of a foam from the composition according to the invention. The optionally added fibers are usually known fiber materials which can be added to a polymer composition. In a particularly suitable version of the present invention, the fibers are PEI, PEEK, PES, PPSU or blend fibers, the latter from a selection of the mentioned polymers.

The nanoparticles, which may be in the form of tubes, platelets, rods, spheres or other known forms, are usually inorganic materials. These can take over different functions in the finished foam. Thus, these particles partly act as nucleating agents during foaming. Furthermore, the particles can influence the mechanical properties as well as the (gas) diffusion properties of the foam. Furthermore, the particles also contribute to the flame retardancy.

Besides the listed nanoparticles, microparticles or only partially miscible, phase-separating polymers can also be added as nucleating agents. In this case, the polymers described should be considered separately from the other nucleating agents when considering the composition, as these primarily influence the mechanical properties of the foam, the melt viscosity of the composition and thus the foaming conditions. The additional effect of a phase-separating polymer as nucleating agent is an additional desired, but in this case not primary, effect of this component. For this reason, these additional polymers are listed separately from the other additives in the overall balance above.

These polymer blends are processed into foams by known methods. A common process is extrusion. According to the invention, extrusion is used to produce a foam with a density of 10 to 200 kg/m³, determined according to DIN EN ISO 1183. Blowing agent-loaded particles are preferably produced by underwater pelletizing.

The propellant-loaded particles can be produced in different forms.

It is advantageous to produce ellipsoid particles with a mass of 0.5-15 mg, preferably between 1-12 mg, especially preferred between 3 and 9 mg.

Ellipsoids are 3-dimensional shapes, based on an ellipse (2-dimensional). If the semi-axes are the same, the ellipsoid is a sphere, if 2 semi-axes coincide, if the ellipsoid is a rotational ellipsoid (rugby ball), if all 3 semi-axes are different, the ellipsoid is called triaxial or triaxial.

In a particularly preferred variant, a process for producing a particle foam is provided, in which a composition consisting of 87.00 to 99.99% by weight of polyetherimide (PEI), 0.01 to 3% by weight of a nucleating agent and 0 to 10% by weight of additives is compounded in an extruder by means of underwater or strand pelletizing and processed into granules.

The granules obtained are then swollen in a suitable container, e.g. drum, boiler, reactor, with 0.49 to 19.99% by weight of a blowing agent, preferably 1-19% by weight, and the swollen particles are separated and dried via a sieve.

The resulting blowing agent-loaded particles are pre-foamed by heating. Heating is affected by means of IR radiation, fluid (e.g. water vapor), electromagnetic waves, heat conduction, convection or a combination of these processes.

Foam particles are obtained by heating the propellant-loaded particles. These foam particles have a bulk density between 10 and 200 kg/m³, preferably between 30 and 90 kg/m³, determined according to DIN ISO 697 (Publication date: 1984-01).

Preferably, the average cell diameter of the particle foam is 1 mm, preferably <500 μm, especially preferred <250 μm.

In many cases, the size of a cell can be easily measured, for example by means of a microscope. This is particularly applicable when the cell wall between two cells is clearly visible.

As a foamed material, the particle foam according to the invention has a glass transition temperature between 180 and 220° C., preferably between 185 and 200° C.

Specified glass transition temperatures are measured by DSC (Differential Scanning Calometry), unless otherwise specified. The technician knows that the DSC is only sufficiently meaningful if, after an initial heating cycle up to a temperature that is at least 25° C. above the highest glass transition or melting temperature, but at least 20° C. below the lowest decomposition temperature of a material, the material sample is kept at this temperature for at least 2 minutes. Afterwards, it is cooled down again to a temperature which is at least 20° C. below the lowest glass transition or melting temperature to be determined, the cooling rate being a maximum of 20° C./min, preferably a maximum of 10° C./min. After a further waiting period of a few minutes, the actual measurement then takes place, during which the sample is heated at a heating rate of usually 10° C./min or less to at least 20° C. above the highest melting or glass transition temperature.

The foam particles obtained are processed into molded parts by sintering the pre-foamed particles to molded parts with a density of 20 to 200 kg/m³, preferably from 30 to 150 kg/m³, with the aid of a molding tool and energy supply.

Energy is supplied by IR radiation, the use of a suitable fluid (for example steam or hot air), heat conduction or electromagnetic waves.

Alternatively, the foam particles can be bonded using a shaping tool and an additive.

The produced particle foam is particularly preferred—regardless of the process used—then bonded, sewn or welded to a covering material. Welded means that by heating the components, a bond (adhesion) is created between the foam core and the cover materials.

The covering material can be wood, metals, decorative foils, composite materials, prepregs, fabrics or other known materials.

For example, it can be a foam core with thermoplastic or crosslinked cover layers. The state of the art describes various processes for the production of composite parts.

A preferred process for the production of a composite part is characterized in that the particle foam produced according to the invention is foamed in the presence of a covering material in such a way that it is joined to the latter by means of adhesive bonding or welding.

In the process variant in which the loading with blowing agent takes place in the extruder, the PEI can alternatively be processed into semi-finished products (foam extrusion) by means of a suitable nozzle, optionally in combination with covering materials, even when it exits the extruder.

Alternatively, the composition can be foamed directly by molding (foam injection molding) using a foam injection device.

Regardless of the variants used, the particle foams or composite materials can be provided with inserts during foaming and/or channels can be built into the particle foam.

Preferably, the foams according to the invention exhibit a degree of foaming that results in a reduction of density compared to the unfoamed material of between 1 and 98%, preferably between 50 and 97%, especially preferred between 70 and 95%. Preferably the foam has a density between 20 and 200 kg/m³, preferably between 30 and 150 kg/m³.

Basically, there are two preferred procedures for the production of particle foams according to the invention. In the first process variant, a composition consisting of 77.01 to 99.5% by weight of PEI, 0.49 to 19.99% by weight of a blowing agent, 0.01 to 3% by weight of a nucleating agent and 0 to 10% by weight of additives is processed by means of an extruder with die plate by means of underwater pelletizing to form a foamed granulate.

In this process, the propellant-loaded polymer melt is cooled to temperatures between 180 and 250° C. and conveyed with suitable conveying means (e.g. a gear pump) through a die plate and pelletizing of the propellant-loaded polymer melt in an underwater pelletizer. The underwater pelletizer is operated without pressure at water temperatures between 50 and 99° C.

Preferably the blowing agent is loaded in the extruder. The granulate then foams as it leaves the die plate. The foamed granulate is then preferably foamed further into a particle foam.

In a variant of this design, the composition can be fed into an underwater pelletizer as it exits the extruder. The pelletizer is designed with regard to a combination of temperature and pressure in such a way that foaming is prevented. This procedure produces a granulate loaded with blowing agent, which can later be foamed to the desired density by renewed energy supply and/or further processed into a particle foam workpiece with optional shaping.

In a second process variant for the production of a particle foam, a corresponding composition as described for the first variant is also first processed into a granulate by means of an extruder with perforated plate, but not loaded with a blowing agent. Here the granulate is then loaded with a blowing agent in an autoclave or a stirred pressureless container in such a way that it contains between 0.01 and 19.99% by weight, preferably between 0.49 and 19.99% by weight, of blowing agent. The granules loaded with blowing agent can then be foamed to form a particle foam by expansion and/or by heating to a temperature above 100° C.

With regard to the foaming process, technicians are already familiar with various methods for foaming polymer compositions which are applicable to the present composition, particularly with regard to methods for thermoplastic foams. For example, the composition can be foamed at a temperature between 150 and 250° C. and a pressure between 0.1 and 2 bar. Preferably, the foaming, if not subsequent to extrusion, takes place at a temperature between 180 and 230° C. in a normal pressure atmosphere.

In the variant of subsequent loading with a blowing agent, a composition, still without a blowing agent, is loaded with the blowing agent in an autoclave or a stirred pressureless container at a temperature, e.g. between 20 and 120° C., and a pressure of 0 bar, in an autoclave preferably at 30 and 100 bar, and then foamed by reducing the pressure and increasing the temperature to the foaming temperature in the autoclave. Alternatively, the composition to which the blowing agent has been added is cooled in the autoclave and removed after cooling. This composition can then be foamed later by heating it to the foaming temperature. This foaming can also be done by further shaping or combining it with other elements such as inserts or cover layers.

The foams produced according to the process according to the invention are used in the construction of aerospace industry, shipbuilding, rail vehicle construction or automotive vehicle construction, especially in their interior or exterior. This can include particle foams, produced according to the process of the invention or not, as well as the composite materials produced from them. Due to their low flammability in particular, the foams according to the invention can also be used in the interior of these vehicles. Furthermore, it is also inventive to use the materials mentioned above in shipbuilding, automotive vehicle construction or rail vehicle construction.

PEI particle foams are particularly suitable for installation in the interior of an aircraft. Aircrafts include in particular not only jets or small aircraft but also helicopters or even spacecrafts. Examples for the installation in the interior of such an aircraft are, for instance, the fold-out trays on the back of a passenger aircraft seat, the filling of a seat or a partition wall as well as, for example, in interior doors.

PEI particle foams are also particularly suitable for installation in the exterior of an aircraft. Exterior area not only means a filling in the outer skin of an aircraft, but especially also in an aircraft nose, in the tail area, in the wings, in the outer doors, in the rudders or in rotor blades.

The process according to the invention provides temperature-resistant, flame-retardant foam materials suitable for use in the aerospace industry.

1. A process for producing a polyetherimide (PEI) particle foam, the process comprising:
mold foaming a polymer mixtures wherein a particle foam formed during the mold foaming is flushed with a fluid and wherein a blowing agent is discharged, to obtain the PEI particle foam, and,
optionally, thermally treating the PEI particle foam,
wherein the PEI particle foam has a glass transition temperature between 180 and 220° C., measured according to DIN EN ISO 6721-1: 2011-08, and an average cell diameter of the PEI particle foam is less than 1 mm with a density of 20-200 kg/m³ determined according to DIN EN ISO 1183-1: 2013-04, and
wherein in a molded part of the PEI particle foam with a thickness of 2-60 mm, the energy release according to AITM 2.0006 is a maximum of 65 kW/m² (HRR), and within 2 minutes test duration is 2-65 kWmin/m² (FIR), wherein a sample size is 150 mm×150 mm× installation thickness.

2. The process for the production of a PEI particle foam according to claim 1, wherein the thermal treatment is a tempering at a temperature of 50-200° C. for 0.1 h to 72 h.

3. The process for the production of a PEI particle foam according to claim 1, wherein the fluid is steam or hot air.

4. The process for the production of a PEI particle foam according to claim 1, wherein in the molded part with a thickness of 5-20 mm, the energy release according to AITM 2.0006 is at most 65 kW/min² (HRR) and within 2 minutes test duration is 10-65 kWmin/m² (HR).

5. The process for producing a PEI particle foam according to claim 1, wherein the polymer mixture consists of:
77.01 to 99.5% by weight of PEI,
0.49 to 19.99% by weight of the blowing agent,
0.01 to 3% by weight of a nucleating agent, and
0 to 10% by weight of at least one additive.

6. The process for the production of a PEI particle foam according to claim 1, wherein the polymer mixture comprises at least one additive selected from the group consisting of flame-retardant additives, plasticizers, pigments, UV stabilizers, nucleating agents, impact strength modifiers, adhesion promoters, rheology modifiers, chain extenders, fibers, and nanoparticles.

7. The process for producing a PEI particulate foam according to claim 1, wherein the blowing agent is an alcohol, a ketone, an alkane, an alkene, CO₂, N₂, water, an ether, an aldehyde, a chemical blowing agent, or a mixture thereof.

8. A method, comprising:
installing the PEI particle foam produced by the process according to claim 1, in the interior of an aircraft.

9. A method for producing a composite component, the method comprising:
bonding, sewing, or welding the PEI particle foam produced by the process according to claim 1, to a covering material.

10. A method, comprising:
installing the composite component obtained from the method according to claim 9, in an aircraft, ship, rail vehicle, or automotive vehicle.
